(19) United States
(12) Patent Application Publication
(10) Pub. No.: US 2016/0370273 A1
(43) Pub. Date: Dec. 22, 2016

(54) A METHOD AND SYSTEM FOR MEASURING SURFACE TENSION

(71) Applicant: STELLENBOSCH UNIVERSITY, Western Cape Province (ZA)

(72) Inventors: Cornelius Louwrens PIETERSE, Kenhardt, Northern Cape (ZA); Paul PAPKA, Cape Town (ZA)

(21) Appl. No.: 15/122,145

(22) PCT Filed: Feb. 27, 2015
(86) PCT No.: PCT/IB2015/051461

§ 371 Date: Aug. 26, 2016

(30) Foreign Application Priority Data
Feb. 28, 2014 (ZA) 2014/01533

(51) Int. Cl. G01N 13/02; G01N 27/00

(52) U.S. Cl. CPC G01N 13/02; G01N 27/00

(57) ABSTRACT

A method for measuring a surface tension of a liquid is carried out using an electrospraying apparatus connected in a system. A voltage source applies a voltage between a capillary through which the liquid is drawn and an electrode of the electrospraying apparatus. An ammeter continuously measures current flowing in the system and if no current or a current less than a predetermined threshold current is measured in the system, the strength of the electric field at the capillary is increased. As soon as current is measured in the system, a reading of a parameter of the system is taken, which is used to calculate the surface tension of the liquid.

### CROSS-REFERENCE(S) TO RELATED APPLICATIONS

This application claims priority to South African provisional patent application number 2014/01533 filed on 28 Feb. 2014, which is incorporated by reference herein.

### FIELD OF THE INVENTION

This invention relates to a method and system for measuring the surface tension of liquids. In particular, it relates to a rapid method of measuring surface tension with a system that is configured to use a relatively small volume of liquid per analysis.

### BACKGROUND TO THE INVENTION

Surface tension is a term that describes the tension that results from cohesive forces between liquid molecules at an interface between a liquid and a gas. It is the property of the surface of a liquid that allows it to resist an external force.

The surface tension of a liquid is related to the physical properties of the liquid. Therefore, systems that measure the surface tension of liquids have wide-ranging applications. In many scientific, engineering and medical applications, it is either necessary to determine the surface tension of a liquid or, for a variety of purposes, to at least have an indication of the surface tension of a specific liquid. Various techniques and devices exist for measuring the surface tension of liquids. These include, amongst others, the capillary rise, Du Noüy ring, Wilhelmy plate, drop weight and the bubble pressure method.

Common problems associated with known techniques and devices for measuring surface tension include, for example, that they are limited in the types of liquids for which they can be used. In addition, known methods can typically be time consuming and may require several seconds or in most cases minutes of analysis to determine the surface tension of a particular liquid.

Moreover, known methods generally require a large volume of liquid, varying between 10 and 30 ml, to be able to determine the surface tension of the liquid with reasonable accuracy. To the applicant's knowledge, recent developments regarding a minimized version of the Du Noüy ring method requires approximately 50 μl of liquid in order to yield useful results. While such volumes are much more acceptable, it is desirable to use even smaller volumes of liquid in a single measurement, such that measurements can be done with liquids that are not readily available and/or such that multiple measurements can be done on a single sample.

An electrospray is an apparatus that employs electricity to produce a fine spray of nano- or micro-sized droplets. Electrosprays are used in electrospray ionization applications such as mass spectrometry, the electrospinning of nanofibres, space-based electrostatic propulsion systems, the deposition of particles for nanostructures, drug delivery, air purification, and advanced printing techniques, amongst others.

An electrospray apparatus in its most basic form includes a chamber for holding a liquid connected to a capillary with a small aperture at its tip that channels the liquid to be sprayed through the aperture. The capillary acts as a first electrode and a second counter electrode is positioned at an appropriate distance from the capillary. A voltage source applies a voltage to the electrodes. In use, the liquid to be sprayed is drawn out of the capillary to form a droplet at the aperture of the capillary and at a particular threshold voltage, the electric field at the tip of the capillary is sufficiently strong such that the slightly rounded tip of the liquid inverts, i.e. forms a Taylor cone, and emits a jet of liquid. As this jet travels away from the aperture, it eventually becomes unstable and separates into a spray of highly charged droplets.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a method of measuring a surface tension of a liquid, the method being carried out using an electrospraying apparatus connected in a measuring system and comprising the steps of:
applying, with a voltage source, a voltage between a capillary of the electrospraying apparatus through which the liquid is drawn and an electrode of the electrospraying apparatus;
measuring if current is flowing in the system;
if no current or a current less than a predetermined threshold current is measured in the system, increasing the strength of an electric field at the capillary; and
taking a reading of a parameter of the system as soon as a current or a current greater than the predetermined threshold current is measured in the system, the reading of the parameter being useful in calculating the surface tension of the liquid.

A further feature of the invention provides for the step of increasing the strength of the electric field at the capillary to include increasing the applied voltage between the capillary and the electrode of the electrospraying apparatus, preferably in predefined and distinct increments.

A further feature of the invention provides for the step of taking a reading of a parameter of the system to include taking a reading of the applied voltage.

Yet a further feature of the invention provides for the step of increasing the strength of the electric field at the capillary to include decreasing a distance between the capillary and the electrode, preferably in predefined and distinct increments.

Still a further feature of the invention provides for the step of taking a reading of a parameter of the system to include taking a reading of the distance between the capillary and the electrode.

A further feature of the invention provide for at least the steps of monitoring the ammeter, increasing the strength of the electric field and taking a reading of the parameter of the system that was adjusted to increase the strength of the electric field to be controlled by a processing module onto which machine readable instructions for generating suitable control signals to a motor, ammeter and voltmeter are loaded.

Yet a further feature of the invention provide for the current measured in the system, or a current that is greater than a predetermined threshold current to result from an electrospray of the liquid between a tip of the capillary and the electrode which completes an electrospraying circuit, the electrospray indicating that the surface tension force of the liquid has been overcome by forces from the applied electric field.

Still a further feature of the invention provides for the predetermined threshold current to be a background current contribution from corona discharges and/or ion emissions.

A further feature of the invention provide for the method to include the step of calculating the surface tension of the liquid taking into consideration one or more of the readings taken from the voltage source or a voltmeter, a distance between a tip of the capillary and the electrode, a vacuum permittivity constant and a selected radius of an aperture in the tip.

The invention also provides for a system for measuring a surface tension of a liquid, comprising:
an electrospraying apparatus including a chamber for housing the liquid, a conductive capillary through which the liquid is drawn, a tip of the capillary defining an aperture therein which forms an outlet for the capillary, at least one electrode positioned proximate the tip and a voltage source configured to apply a voltage and thereby create an electric field between the tip and the electrode;
an ammeter connected in series with the capillary and the electrode; and
a processing module configured to monitor the ammeter, to adjust a parameter of the system that increases the applied electric field if no current or a current less than a predetermined threshold current is measured, and to read the parameter as soon as a current or a current greater than the predetermined threshold current is detected in the system, the reading being useful in calculating the surface tension of the liquid.

A further feature of the invention provides for the voltage source to be a programmable and adjustable direct current voltage source.

Yet a further feature of the invention provides for the processing module to be configured to increase the voltage applied between the tip of the capillary and the electrode and to read a voltage from the voltage source as soon as a current or a current greater than the predetermined threshold current is detected in the system.

Still further features of the invention provide for a voltmeter to be connected in parallel with the voltage source and for the processing module to be configured to read a voltage from the voltmeter as soon as a current or a current greater than the predetermined threshold current is detected in the system.

A further feature of the invention provides for a software application to be resident on the processing module and executable by the processing module to increase the applied voltage in predefined voltage increments within a selected voltage range, and to stop increasing the applied voltage when a current or a current greater than the predetermined threshold current is detected by the ammeter in the system.

Yet a further feature of the invention provides for the tip and the electrode to be positioned a specific, predefined distance apart, preferably a distance that is approximately ten times that of the radius of the aperture in the capillary.

In one embodiment of the invention, the system includes at least one electrical actuator which is mechanically connected to one or both of the electrode and the capillary and is operable to adjust the distance between the tip of the capillary and the electrode.

Further features of this embodiment of the invention provide for the at least one electrical actuator to be programmable and for a processing module in electronic communication with the at least one electrical actuator and the ammeter to be configured to continuously monitor the ammeter, to decrease the distance between the capillary and the electrode, and to read a distance as soon as a current is detected in the system, the distance reading being useful in calculating the surface tension of the liquid; for a software application to be resident on the processing module and executable by the processing module to decrease the distance between the capillary and electrode in predefined increments within a selected distance range, and to stop decreasing the distance when a current or a current greater than the predetermined threshold is detected by the ammeter in the system.

Yet a further feature of the invention provides for the aperture in the tip to have a predefined radius, preferably a radius of approximately 5 μm.

Still a further feature of the invention provides for the tip to be coated with or made from a material selected from gold, platinum, silver, copper or their alloys.

A further feature of the invention provides for the system to include a heating and/or cooling unit and an external temperature controller configured to heat or cool the capillary so as to measure a surface tension of a liquid at different temperatures.

Further features of the invention provide for the electrospray apparatus to be configured to electrospray under atmospheric conditions or for at least the electrospray apparatus to be isolated in a hermetically sealed container and for the container to be filled with an isolation medium other than air.

### BRIEF DESCRIPTION OF THE DRAWINGS

The invention will now be described, by way of example only, with reference to the accompanying representations in which:

FIG. 1 is a schematic illustration of a first embodiment of a system for measuring the surface tension of a liquid according to the invention;

FIG. 2 is a flow diagram that illustrates a first embodiment of a method of measuring the surface tension of a liquid using the system of FIG. 1;

FIG. 3 is a schematic illustration of a second embodiment of a system for measuring the surface tension of a liquid according to the invention; and

FIG. 4 is a flow diagram that illustrates a second embodiment of a method of measuring the surface tension of a liquid using the system of FIG. 3.

### DETAILED DESCRIPTION WITH REFERENCE TO THE DRAWINGS

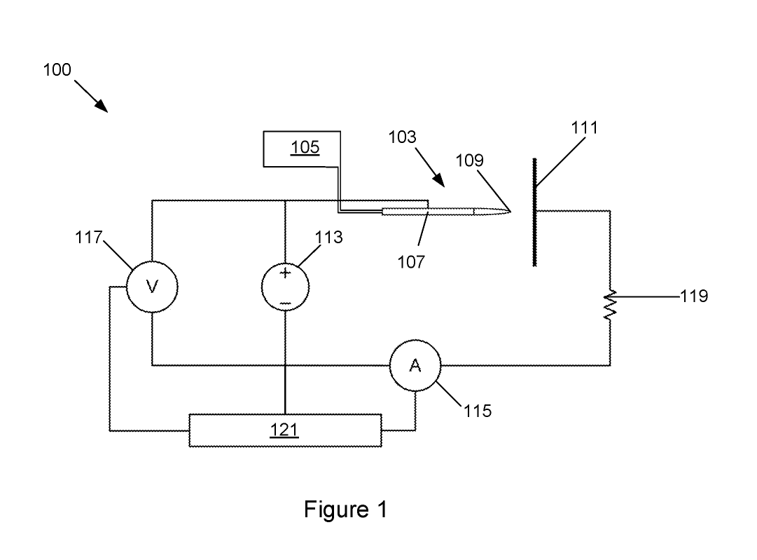

In the embodiment of the invention illustrated in FIG. 1, a system (100) for measuring a surface tension of a liquid is shown. The system (100) includes an electrospraying apparatus (103) comprising a chamber (105) for housing a liquid. A conductive capillary (107) extends from the chamber and terminates in a narrow tip (109) which has a small aperture that forms an outlet for the capillary. The tip (109) is selected to be coated with or made from a material selected from gold, platinum, silver, copper or their alloys. An electrode (111) is positioned proximate the tip at a selected distance of approximately ten times that of the radius of the aperture in the tip (109), however the separation distance may be varied depending on the experimental conditions required. The electrode (111) has any suitable shape and size in accordance with the required electric field characteristics, it can, for example, be a plate with a planar surface or a ring electrode. An adjustable, direct current voltage source (113) is connected across the electrode (111) and the capillary (107) so as to apply an adjustable voltage between them. An ammeter (115) is connected in series with the electrode (111) and capillary (107) to measure the current in the electrospraying system (100) and a voltmeter (117) is connected in parallel with the voltage source (113). A resistor (119) is connected in series with the electrospray apparatus that acts as a ballast to stabilise the current, decrease the likelihood of undesirable electrical discharges occurring and stabilise the electrospray of a liquid. The system (100) is further provided with a processing module (121) in electronic communication with the voltage source (113), voltmeter (117) and ammeter (115). The processing module (121) is configured to continuously monitor the ammeter and to increase the voltage applied by the voltage source (113), as well as to take readings of the voltage and current. It should be appreciated that in order to do so, the processing module (121) may have suitable software operating thereon, which is capable of issuing instructions to the various components of the system (100) to allow it to perform the appropriate functions.

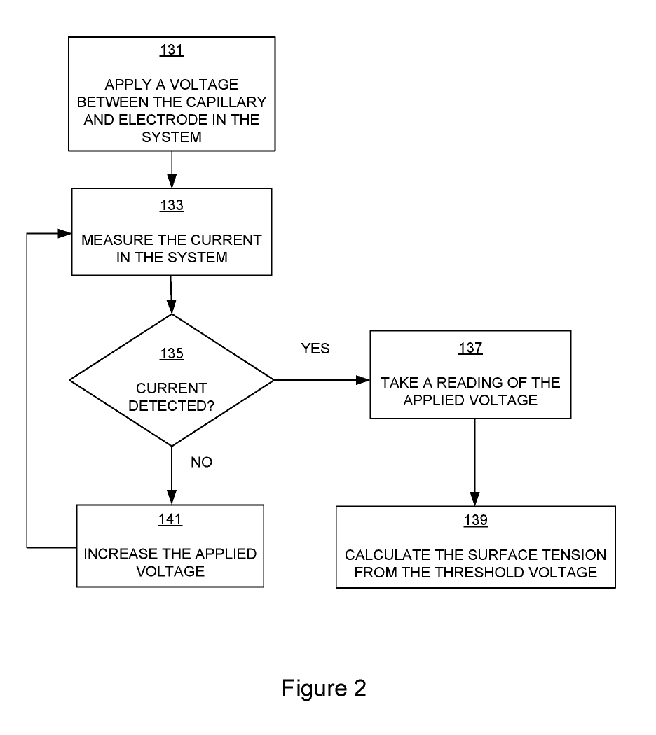

A method of determining the surface tension of a liquid using the system (100) described above with reference to FIG. 1 will now be described with reference to the flow diagram shown in FIG. 2. At a first step (131), a voltage is applied between the capillary and electrode of the electrospraying apparatus. At a next step (133), the processing module continuously monitors the ammeter to detect and measure any current that flows in the system. If no current is detected in the system at step (135), the processing module issues instructions to the voltage source to incrementally increase the applied voltage at step (141). Once the voltage has been increased, the system resumes to monitoring the ammeter for current flowing in the system at step (133).

If a current is detected in the system at step (135), the processing module takes a reading of the exact voltage applied by the voltage source from the voltmeter at step (137). Obviously as soon as a current is detected in the system at step (135), it implies that the surface tension of the liquid has been overcome, that an electrospray has occurred and that charged particles are making their way across the gap between the tip of the capillary and the electrode, thereby allowing current to flow in the system. The exact voltage reading at which a current starts flowing therefore corresponds to the voltage that is required to overcome the surface tension of the liquid in the electrospray apparatus, and is then used at step (139), to calculate the surface tension of the liquid. If a background current from corona discharge, ion emissions or the like is measured in the system prior to electrospray, the method will be accordingly modified such that the current detected in the system at step (135) must be more than a predetermined threshold current before the processing module takes a reading of the applied voltage at step (137).

As is common with electrospraying apparatuses, the liquid is drawn through the chamber to the tip by the voltage or potential difference between the tip and the electrode. A pump may be provided in the system to pump liquid from the chamber into the capillary.

Using software that is programmed onto a memory of the processing module, it is possible to program the adjustable direct current voltage source in such a manner that it iterates from a zero voltage, in predefined increments, to a voltage at which electrospraying occurs and a net current is detected in the system. Such a voltage is commonly referred to as a threshold voltage. When the particular threshold voltage for the liquid is reached, the electric field at the tip of the capillary and the associated Coulombic repulsion between like charges on the surface of the liquid present at the tip of the capillary causes the rounded tip of the meniscus of the liquid to deform and a jet of particles, which is referred to as an electrospraying cone-jet or Taylor cone, to be expended.

As the jet travels away from the tip, it becomes unstable and disintegrates into a plume of highly charged droplets. The droplets generated can have charge magnitudes close to half the Rayleigh limit, which is the magnitude of charge required to overcome the surface tension force and promote droplet fission. The movement of the droplets from the tip of the capillary towards the electrode forms a net ion current that completes the electrospraying circuit such that a net current is detected by the ammeter. When the current is detected, the specific applied voltage can be used to determine the surface tension of the liquid under investigation.

In one embodiment of the invention, the strength of the electric field at the tip of the capillary is varied by changing the distance between the tip of the capillary and the electrode whilst the voltage applied to the system is kept constant. In this embodiment, a threshold distance, which is a distance between the capillary tip and the electrode at which electrospraying occurs, can be used to measure the surface tension of a liquid.

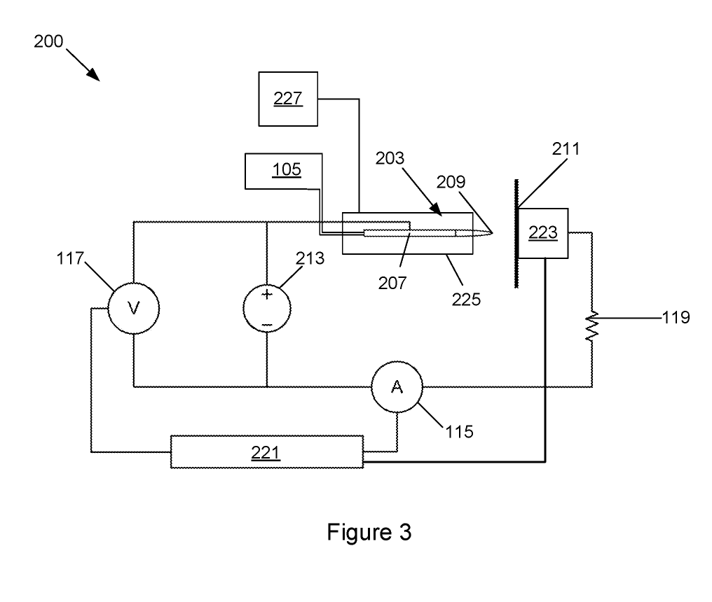

A second embodiment of a system (200) for measuring the surface tension of a liquid according to the invention is illustrated in FIG. 3. In FIG. 3, like reference numerals used with reference to FIG. 1 above are used to refer to like features. The system (200) includes a programmable motor as an electrical actuator, in this embodiment a programmable step motor (223) that is configured to move the electrode (211) relative to the tip of the capillary so as to vary the distance between the tip (209) of the capillary (207) and the electrode (211). Preferably, a nanostep motor is used to ensure that the steps taken are sufficiently small. A processing module (221) is in electronic communication with the step motor (223), ammeter (115) and, in this embodiment, the voltmeter (117). The processing module (221) is configured to continuously monitor the ammeter (115) and to instruct the step motor (223) to decrease the distance between the tip (209) of the capillary (207) and the electrode (211) in predefined increments within a selected distance range and to stop decreasing the distance when a current or a current above the predetermined threshold is detected by the ammeter (115) in the system (200). It should be appreciated that in order to do so, the processing module (221) may have suitable software operating thereon, which is capable of issuing instructions to the various components of the system (200) to allow it to perform the appropriate functions.

The step motor (223) may be provided with a controller or processor for generating step signals and a driver configured to convert the signals into power that energises the step motor. In the embodiment shown in FIG. 3, the step motor is operable to move the electrode (211), while in other embodiments the step motor may be operable to move the capillary (207) towards the electrode (211) or to move both the capillary (207) and the electrode (211). However, it is foreseen that the vibrations associated with the operation of the step motor may affect the electrospraying process if the step motor is operable to move the capillary.

The processing module (221) is further configured to read a distance between the capillary and electrode, optionally, using data from the step motor, as soon as a current or a current above the predetermined threshold is detected in the system, the distance reading being useful in calculating the surface tension of the liquid. In the embodiment shown in FIG. 3, the voltage source (213) need not be an adjustable or programmable voltage source, as the applied voltage must remain constant to measure the surface tension using the system (200).

In the embodiment of the invention illustrated in FIG. 3, borosilicate glass capillaries are used, which permits the temperature at which the measurement of surface tension is performed to be varied, using a heating or cooling unit (225) and an external temperature controller (227) configured to heat or cool the capillary and thus the liquid that is under investigation. The system and method of the invention therefore also lends itself to conducting variable temperature surface tension measurements. The maximum temperature at which a determination can be done may be limited by the thermal properties of the material that the capillary is made of and the temperature at which the sample evaporates. The softening point of borosilicate glass, for example, is approximately 820° C. Borosilicate glass also has a low thermal expansion coefficient, which makes it suitable for variable temperature measurements in an electrospraying apparatus.

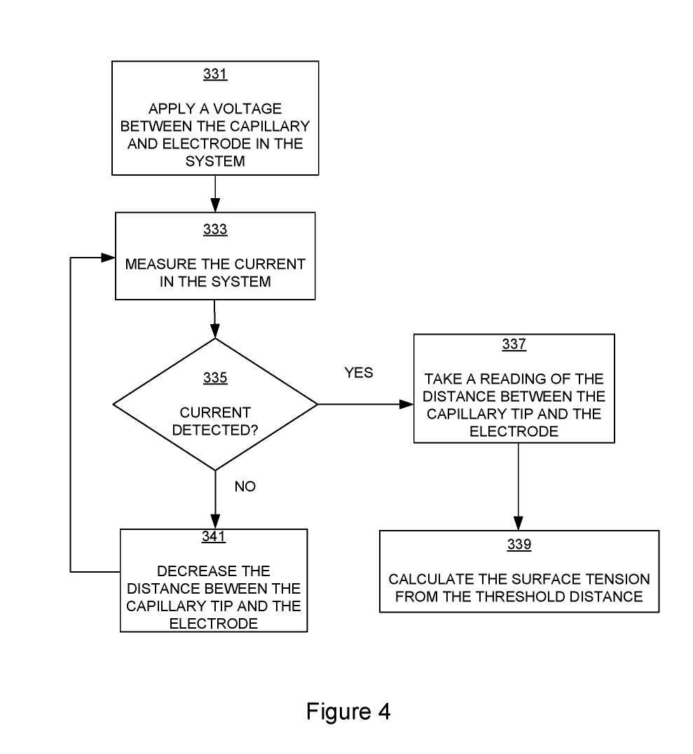

A method of determining the surface tension of a liquid using the system (200) described above with reference to FIG. 3 will now be described with reference to the flow diagram shown in FIG. 4. At a first step (331), a voltage is applied between the capillary and electrode of the electrospraying apparatus. At a next step (333), the processing module continuously monitors the ammeter to detect and measure any current that flows in the system. If no current is detected in the system at step (335), the processing module issues instructions to the step motor to incrementally decrease the distance between the tip of the capillary and the electrode at step (341). Once the distance has been decreased, the system resumes to monitoring the ammeter for current flowing in the system at step (333).

If a current is detected in the system at step (335), the processing module takes a reading of the exact distance between the tip of the capillary and the electrode at step (337). Obviously as soon as a current is detected in the system at step (335), it implies that the surface tension of the liquid has been overcome, that an electrospray has occurred and that charged particles are making their way across the space between the tip of the capillary and the electrode, thereby allowing current to flow in the system. The exact distance reading at which a current starts flowing therefore corresponds to the separation distance that is required to result in an electric field at the capillary tip that is able to overcome the surface tension of the liquid in the electrospray apparatus, and is then used at step (339), to calculate the surface tension of the liquid.

It has been shown that slightly conductive liquids may be channelled through a capillary and then electrosprayed from the capillary aperture once the electric field the liquid drop experiences at the tip of the capillary is strong enough such that the surface tension of the liquid is overcome.

The electric field at the capillary tip (Eₜᵢₚ) is given by the following equation:

$${E}_{tip} = \frac{2 V}{R ln ( \frac{4 L}{R} )} , \qquad ( 1 )$$

wherein, V is the applied voltage, R is the capillary radius, and L is the distance between the tip of the capillary and the electrode. The above equation does not take into account the effect of space charge, which would result in a reduced field at the liquid tip and is only valid for R<<L [symbol] 10R≦L. The effects of polarization fields on the electric field are described further below, with references to equation 11.

The critical voltage (V_{crit}) and electric field (E_{crit}) applied to the tip and the electrode, initiating the liquid surface instability and therefore leading to electrospraying are given by the equations:

$${V}_{crit} = \sqrt{\frac{γ R}{{ɛ}_{0}}} ln ( \frac{4 L}{R} ) \\ and \\ {E}_{crit} = 2 \sqrt{\frac{γ}{{ɛ}_{0} R}} , \qquad ( 2 )$$

wherein γ is the liquid surface tension and ∈₀ is the vacuum permittivity.

When the Taylor cone is generated, a net ion current (I) is observed as the charged droplets are moving between the capillary and the electrode:

$$I = \frac{f ( ɛ )}{\sqrt{ɛ}} \sqrt{γ KQ} , \qquad ( 3 )$$

wherein ∈ is the relative permittivity of the liquid, K is the electrical conductivity of the liquid, Q is the volumetric flow rate and wherein the empirical function f(∈)=∈/2 is defined for ∈<40 and f(∈)=20 for ∈≧40 respectively.

The measurable current can be increased by applying a hydrostatic pressure to the liquid to be dispensed through the tip, however this will influence the amount of sample used during a single measurement and it will adjust the threshold voltage at which electrospraying occurs, which is not desirable.

As described above with reference to FIGS. 2 and 4, the surface tension of a liquid can be measured by one of two possible methods. The first method includes the step of increasing the applied voltage while the distance between the capillary tip and electrode is kept constant. The second method includes the step of decreasing the distance between the capillary tip and electrode while the applied voltage is kept constant.

Using the first method, the surface tension is obtained by rewriting equation 2 as:

$$γ = \frac{{ɛ}_{0}}{R} {( \frac{{V}_{crit}}{ln ( \frac{4 L}{R} )} )}^{2} , \qquad ( 4 )$$

which can be simplified by taking the following constants:

$$α = \frac{{ɛ}_{0}}{R} \\ and \\ β = {( ln ( \frac{4 L}{R} ) )}^{- 1} . \qquad ( 5 )$$

The final equation is then given as:

γ=α(βV_{crit})². (6)

As can be seen from equation 6, the voltage at which electrospraying occurs (V_{crit}) is proportional to the liquid surface tension (γ). Equation 2 is used to calculate the voltage at which the electrospraying initiates. Therefore, using equation 6, it is possible to determine the surface tension from the voltage measurement at which spraying initiates, when the distance between the capillary tip and electrode is constant.

Using the second method, the surface tension is obtained by rewriting equation 2 as:

$$γ = \frac{{V}^{2} {ɛ}_{0}}{R} {( \frac{1}{ln ( \frac{4 {L}_{crit}}{R} )} )}^{2} , \qquad ( 7 )$$

which can be simplified by taking the following constant:

$${α}_{L} = \frac{{V}^{2} {ɛ}_{0}}{R} . \qquad ( 8 )$$

The final equation is then given as:

$$γ = {α}_{L} {ln ( \frac{4 {L}_{crit}}{R} )}^{- 2} . \qquad ( 9 )$$

As can be seen from equation 9, the distance between the tip of the capillary and the electrode (L_{crit}) is inversely proportional to the surface tension. Therefore, using equation 9 it is possible to determine the surface tension from the distance between the capillary tip and electrode at which spraying occurs, when the applied voltage of the system is constant. For both of the approaches the same critical electric field, as given by equation 2, is required to overcome the surface tension of the liquid.

The main effects that limit the capabilities of the invention are electrical and corona discharges. It has been found that the voltage range or separation distance range of the system can be adapted to detect lower surface tensions, while the maximum measurable surface tension may be limited by the onset electric field of corona discharges. The electric fields generated by some electrospraying geometries are inhomogeneous, causing electric and, more specifically, corona discharge to occur before electrospraying. Corona discharge is an electrical discharge brought on by the ionization of fluid surrounding a conductor that is electrically energized. These types of discharges may occur when the strength of the electric field around a conductor is high enough to form a conductive region, but not high enough to cause electrical breakdown or arcing to nearby objects. Corona discharges are undesirable, as they result in sudden current increases that affect the Taylor cone stability, shorten capillary lifetimes and, most importantly, interfere with the detection of the threshold voltage or threshold distance at which electrospraying occurs.

Consequently, the corona onset fields (E_{C}) must be considered, as these fields will determine the limitations of the method and system described, and can be determined according to the following equation:

$${E}_{C} = {E}_{O} - {E}_{P} + χ ( p , φ , T ) = ( \frac{b ɛ + 1}{b ɛ} ) {E}_{O} , \qquad ( 10 )$$

wherein E_{O} is the corona onset field of the Rousse model and E_{P} is the polarization field at the capillary tip; with the function b(R)=p1·R+p2, and wherein p1=11229 m⁻¹ and p2=0.1092. The function χ accounts for empirical experimental factors (pressure p, humidity φ and temperature T). It has been proposed that calculating the polarization fields of electrospraying geometries is necessary:

$${E}_{P} = \frac{- {E}_{tip}}{2 ɛ + 1} = \frac{- 2 V}{( 2 ɛ + 1 ) R log ( 4 L / R )} . \qquad ( 11 )$$

Cloupeau proposed an approximation method, to calculate corona onset fields for such geometries. This adapted version was first postulated by Rousse:

$$\begin{matrix}{E}_{O} = 30 + 9 {R}^{- 0.5} R \geq 100 μm \\ = 62.7 + 1.74 {R}^{- 0.75} 15 μm < R < 100 μm ,\end{matrix} \qquad ( 12 )$$

with results of the form kV/cm. Cloupeau verified that these equations hold for the above and radii as small as 2.5 μm. The above Rousse model is permittivity independent, and therefore does not account for polarization effects.

A model that is similar to the Rousse model is used to calculate the corona discharge onset (E_{C}) for the current invention in terms of the specific geometry of the aperture of the tip and the relative permittivity of most liquids. Using this model and for one embodiment of the invention, in which air is the isolation medium between the capillary and electrode, for example under atmospheric conditions, an average relative permittivity upper limit of E=10 is employed (determined using published dielectric statistics) to determine the maximum surface tensions measurable under atmospheric conditions before the corona discharge onset:

$${γ}_{C} = \frac{R {ɛ}_{0}}{4} {E}_{C}^{2} , \\ suggesting \\ {γ}_{C} ∼ {R}^{- 0.5} . \qquad ( 13 )$$

The maximum surface tension that can be measured before corona discharges occur is inversely proportional to the size of the aperture radius, therefore, an aperture radius of 5 μm or less is preferred. For a proposed minimum aperture radius (R) of 5 μm, an upper limit for the surface tension measurable before corona onset (γ_{C}) of approximately 80 mN/m is obtained.

The accuracy of the system will primarily depend on the size of the predefined increments in which the applied voltage is increased or the distance between the capillary and electrode is decreased. In the first embodiment of the invention in which the electric field is varied by means of adjusting the voltage, voltage resolutions of 2 mV have been obtained. However, if a voltage resolution of 10 mV is assumed for the purposes of the current embodiment, a surface tension of a liquid can be measured with a calculated resolution of approximately 2 μN/m. It is foreseen that the accuracy or resolution of the system will be improved if the voltage is kept constant and the distance between the capillary and electrode is varied with a step motor, as it is possible to obtain higher resolution mechanical actuators than voltage sources. The only disadvantage of incorporating a motor may be that the incorporation of mechanical actuators may introduce vibrations and possibly other sources of error.

The accuracy will also depend on the synchronization quality between the ammeter and voltage source or the synchronization quality between the ammeter and step motor afforded by the processing module. Due to the quadratic form of equation 4 and 7, surface tension determinations will, inherently, be more accurate for lower surface tension liquids.

In the embodiment of the invention in which the distance between the capillary and the electrode is kept constant, an aperture radius of 5 μm or smaller is preferable. If the radius of the aperture in the tip is selected to be 5 μm; the distance between the tip and the electrode should ideally be approximately ten times the radius, in other words 50 μm, in order to reduce the likelihood of electrical discharges occurring when relatively high voltages are applied. A separation distance-radius ratio of approximately 10:1 will result in the highest corona onset fields, enabling measurement of higher surface tension liquids without corona discharges obscuring the current reading. Using the selected distance of 50 μm, the majority of pure liquid compounds can be measured by applying a voltage of less than 800 V. It is possible to use a separation distance-radius ratio of less than 10:1, but then a correction factor must be introduced in the model.

The total time it takes to determine the surface tension of a liquid using the invention is restricted only by the time it takes to form a Taylor cone. The characteristic Taylor cone formation time (T):

$$T = {3}^{\frac{3}{2}} \sqrt{\frac{ρ}{{ɛ}_{0}^{3}}} ( \frac{πγ}{{E}_{tip}^{3}} ) , \qquad ( 14 )$$

wherein, ρ is the liquid mass density. This equation may be simplified by taking constant

$$η = π ( {3}^{\frac{3}{2}} ) ( \sqrt{{ɛ}_{0}^{- 3}} ) ,$$

such that

$$T = η ( \frac{γ \sqrt{ρ}}{{E}_{tip}^{3}} ) .$$

The effects of polarization fields, described above with reference to equation 11 should be considered when calculating the formation time. Due to the lack of physical relation between the surface tension and liquid mass density, it may be required to assume that the liquid possibly has a density as high as 2000 kg/m³.

Using this approach, the maximum time required per voltage or distance increment may be calculated, enabling allocation of sufficient time to wait for electrospray before proceeding to the next voltage or distance. The measurement time is approximately 500 ms for this embodiment of the invention.

The present invention provides numerous advantages over the prior art. One such advantage is that the method and system for measuring the surface tension of liquids is not restricted to only specific liquids. In addition, embodiments of the present invention have been shown to use as little as 5 μl of liquid per measurement owing to the low flow rates of the liquid towards the tip and the small aperture size. The liquid is not under hydrostatic pressure but is drawn out of the capillary by the applied voltage. This sample volume for a single measurement is a fraction of that used by other surface tension measurement methods.

Further advantages of the invention include: measurement times of approximately 500 ms per sample, which is significantly less than is required by other, known methods; and high accuracy with, for instance, a measurement resolution of approximately 2 μN/m when the voltage resolution is set at 10 mV. Using voltage sources that have a superior voltage resolution of 2 mV, it is foreseen that the surface tension resolution may be improved to approximately 0.2 μN/m. This measurement resolution or accuracy is comparable with prior art methods and is attributable to the minimum increments in which the applied voltage can be varied using the voltage source that is available to the applicant. It is foreseen that the embodiment of the system and the method that varies the distance between the capillary and the electrode will be capable of measuring surface tension with greater accuracy than existing systems and methods.

Furthermore, the minimum detectable surface tension of the system and method according to the invention may be as low as approximately 1 mN/m, while the maximum is determined by the maximum voltage that can be applied before corona discharges occur. The applied voltage may be maximized by having a smaller aperture in the tip, such that a shorter distance between the tip and the electrode is necessary and by using an isolation medium other than air such as, for example, an insulating and/or inert gas.

A further advantage of the system of the invention is that, an operator may not have to possess vast technical skills in order to operate the system described.

The above description is by way of example only and it should be appreciated that numerous changes and modifications may be made to the system and method described, without departing from the scope of the invention. It should, for example, be immediately apparent that the voltage applied between the capillary and the electrode need not be increased incrementally, but may also be increased continuously over a predefined voltage range and time period, in which case the rate of the increase of the voltage and a timer may be used to determine the threshold voltage at which a current from electrospray was measured in the system. In a similar manner, the distance between the capillary and the electrode may be continuously decreased in which case the speed of movement of either the capillary, the electrode or both the capillary and the electrode and a timer can be used to determine the exact distance at which a current from electrospray was measured in the system. In such an embodiment of the invention, the need for a step motor is alleviated, and a conventional motor can be used to move the capillary or the electrode closer together.

It should also be apparent that if the voltage source is capable of being digitally controlled by specifying the exact voltage it is to apply, then the need for an additional voltmeter in the system may be alleviated, as the exact voltage applied between the capillary and electrode will already be known to the processing module when a current is detected in the system.

It will also be apparent to those skilled in the art that the operation of system may be controlled by suitable software instructions and algorithms and that the calculations used to derive the surface tension of a liquid from the threshold voltage or threshold distance may be programmed onto the processing module. The system of the invention may therefore be provided as a standalone unit, or may be connectable to existing, external processors or other computers.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of measuring a surface tension of a liquid, the method carried out using an electrospraying apparatus connected in a measuring system and comprising the steps of:
applying with a voltage source, a voltage between a capillary of the electrospraying apparatus through which the liquid is drawn and an electrode of the electrospraying apparatus;
measuring current flowing in the system;
if no current or a current less than a predetermined threshold current is measured in the system, increasing the strength of an electric field at a tip of the capillary; and
taking a reading of a parameter of the system as soon as a current or a current greater than the predetermined threshold current is measured in the system, the reading of the parameter being useful in calculating the surface tension of the liquid.

2. The method as claimed in claim 1, wherein the step of increasing the strength of the electric field at the tip of the capillary includes increasing the applied voltage between the capillary and the electrode of the electrospraying apparatus.

3. The method as claimed in claim 2, wherein the step of increasing the applied voltage includes increasing the voltage in predefined increments.

4. The method as claimed in claim 1, wherein the step of taking a reading of a parameter of the system includes taking a reading of the applied voltage.

5. The method as claimed in claim 1, wherein the step of increasing the strength of the electric field at the tip of the capillary includes decreasing a distance between the capillary and the electrode.

6. The method as claimed in claim 5, wherein the step of decreasing the distance between the capillary and the electrode includes decreasing the distance in predefined increments.

7. The method as claimed in claim 1, wherein the step of taking a reading of a parameter of the system includes taking a reading of the distance between the capillary and the electrode.

8. The method as claimed in claim 1, wherein the current measured in the system, or a current that is greater than a predetermined threshold current, results from an electrospray of the liquid between a tip of the capillary and the electrode which completes an electrospraying circuit, the electrospray indicating that the surface tension force of the liquid has been overcome by forces from the applied electric field.

9. The method as claimed in claim 1, wherein the predetermined threshold current is a background current contribution from corona discharges and/or ion emissions.

10. The method as claimed in claim 1, which includes the step of calculating the surface tension of the liquid taking into consideration one or more of the readings taken from the voltage source or a voltmeter, a distance between a tip of the capillary and the electrode, a vacuum permittivity constant and a selected radius of an aperture in the tip.

11. A system for measuring a surface tension of a liquid, comprising:
an electrospraying apparatus including a chamber for housing the liquid, a conductive capillary through which the liquid is drawn, a tip of the capillary defining an aperture therein which forms an outlet for the capillary, at least one electrode positioned proximate the tip and a voltage source configured to apply a voltage and thereby create an electric field between the tip and the electrode;
an ammeter connected in series with the capillary and the electrode; and
a processing module configured to monitor the ammeter, to adjust a parameter of the system that increases the applied electric field if no current or a current less than a predetermined threshold current is detected, and to read the parameter as soon as a current or a current greater than a predetermined threshold current is detected in the system, the reading being useful in calculating the surface tension of the liquid.

12. The system as claimed in claim 11, wherein the voltage source is a programmable and adjustable direct current voltage source.

13. The system as claimed in claim 11, wherein the processing module is configured to increase the voltage applied between the tip of the capillary and the electrode and to read a voltage from the voltage source as soon as a current or a current greater than a predetermined threshold current is detected in the system.

14. The system as claimed in claim 11, wherein a voltmeter is connected in parallel with the voltage source and the processing module is configured to read a voltage from the voltmeter as soon as a current or a current greater than a predetermined threshold current is detected in the system.

15. The system as claimed in claim 11, wherein a software application is resident on the processing module and executable by the processing module to increase the applied voltage in predefined voltage increments within a selected voltage range, and to stop increasing the applied voltage when a current or a current greater than a predetermined threshold current is detected by the ammeter in the system.

16. The system as claimed in claim 11, which includes at least one electrical actuator which is mechanically connected to one or both of the electrode and the capillary and is operable to adjust the distance between the tip of the capillary and the electrode.

17. The system as claimed in claim 16, wherein the at least one electrical actuator is programmable and a processing module in electronic communication with the at least one electrical actuator and the ammeter is configured to continuously monitor the ammeter, to decrease the distance between the capillary and the electrode, and to read a distance as soon as a current or a current above a predetermined threshold current is detected in the system, the distance reading being useful in calculating the surface tension of the liquid.

18. The system as claimed in claim 17, wherein a software application is resident on the processing module and executable by the processing module to decrease the distance between the capillary and electrode within a selected distance range, and to stop decreasing the distance when a current or a current above a predetermined threshold current is detected by the ammeter in the system.

19. The system as claimed in claim 11, wherein the aperture in the tip has a predefined radius, preferably a radius of approximately 5 μm.

20. The system as claimed in claim 11, which includes a heating and/or cooling unit and an external temperature controller configured to heat or cool the capillary so as to measure a surface tension of a liquid at different temperatures.
